(19) United States
(12) Patent Application Publication
(10) Pub. No.: US 2011/0106630 A1
(43) Pub. Date: May 5, 2011

(54) USER FEEDBACK-BASED SELECTION AND PRIORITIZING OF ONLINE ADVERTISEMENTS

(76) Inventors: John Hegeman, Palo Alto, CA (US); Jared Morgenstern, San Francisco, CA (US)

(21) Appl. No.: 12/611,874

(22) Filed: Nov. 3, 2009

(51) Int. Cl. G06Q 30/00; G06Q 10/00; G06F 3/048; G06F 15/16

(52) U.S. Cl. 705/14.71; 705/14.42; 705/14.44; 705/14.46; 715/764; 709/217; 705/7.35

(57) ABSTRACT

Advertisements to be presented to a user are selected based on feedback responses received from other users where the feedback responses represent the level of interest to the advertisements expressed by the other users. In selecting which advertisements to be presented to a user, the online service takes into account feedback responses previously collected from a group of users and revenue expected for presenting certain advertisements to the user. An online service computing device computes a total value of an advertisement based on an estimated revenue value for presenting an advertisement and a modifier representing the user's estimated interest in the advertisements. The online service then selects or prioritizes the advertisements based on the total values. Advertisements with more positive feedback responses and/or less negative feedback responses tend to have higher total values, and therefore, such advertisements are more likely to be selected for presentation to the users.

### BACKGROUND

This invention relates to selecting and presenting advertisements to users in an online service. More particularly, this invention relates to selecting and presenting advertisements to users in an online service based on previously received user feedback responses related to the advertisements.

Online services, such as social networking services, search engines, news aggregators, Internet shopping services, and content delivery services, have become a popular venue for presenting advertisements to prospective buyers. Some online services provide their services free of charge or charge only minimal fees. Instead, the online services generate advertisements by presenting the advertisements to users or when the users take certain actions based on the presented advertisements (e.g., clicking of the advertisements). The advertisement-based online service model has spawned diverse types of online services.

Online services often use a scheme that charges advertisement fees commensurate with the number of times the advertisements are displayed to the users or actions taken by the users in response to viewing the advertisements. The pricing structure widely used in online services for assessing advertisement fees includes, for example, Cost Per Impression (CPI) and Cost Per Action (CPA). The CPI-based pricing structure assesses advertisement fees based on the number of counts an advertisement is loaded and displayed on a user's screen, typically in response to a user's request for a content item. The CPA-based pricing structure assesses advertisement fees based on actions taken by the users after the advertisements are displayed on the screen. The actions taken into account for the CPA-based pricing structure may include, among others, the following: (i) clicking on the advertisement, (ii) registration to the advertiser's service or product and (iii) conclusion of a sale of a service or product. Rather than using CPI or CPA-based pricing structure, some online services charge a flat fee for displaying an advertisement for a certain amount of time.

Some online services adopt a bidding system that requires multiple advertisers to compete for advertisement space. An advertisement with a higher bidding price is selected and presented to maximize the advertisement fees. The bidding price may be based on CPI, CPA or other expected revenue values. The bidding system may also employ a cap for limiting the amount of advertisement fees for a set period of time (e.g., day or month).

Attractive content items tend to increase user traffic and increase the overall advertisement fees collected by the online services. Hence, online services strive to provide more interesting and attractive content items to the users. The number and content of the advertisements, however, may diminish the attractiveness of the content items. As the number of advertisements displayed in the content item increases, the content items may become over-populated with advertisements and render the content items less appealing. Further, advertisements irrelevant to the user may degrade user's overall experience associated with the online services.

To increase the relevance of the advertisements, some online services analyze information about users and their activities (e.g., search terms used) to target advertisements to the users. These online services estimate or predict the current context of the users' Internet usage based on the user input or user characteristics, and target advertisements most likely to be of interest to the user.

### SUMMARY

Embodiments of the invention relate to selecting advertisements for presentation to a user of an online service. The online service selects the one or more advertisements from a pool of advertisements based in part on feedback about the advertisements received from a group of users who have previously viewed the advertisements. In this way, the online service can take into account not only the expected revenue that it will receive from presenting an advertisement to a user, but also the value to the online service of presenting content to its users that is interesting and that creates a positive experience for the users.

In one embodiment, each advertisement is associated with a bid price, from which the online service can determine an expected revenue to the online service if the advertisement is presented to the user. The online service provider also receives feedback from a group of users representing the level of interest explicitly indicated by the group of users for at least a subset of the advertisements. For each of at least a subset of the advertisements, an expected revenue value for presenting the advertisement to a particular user is calculated based on the bid price. A total value for the advertisement is then computed based on the feedback received for the advertisement. One or more advertisements are then selected from the plurality of advertisements based at least in part on the total values of the advertisements, thereby accounting for both the direct monetary value to the online service as well as the indirect value to the online service of a positive user experience for its users. The selected one or more advertisements are then sent to the particular user.

In one embodiment, a modifier for each advertisement is computed based on the feedback received from the group of users. Then, then total value of each advertisement is computed by adding the modifier for each advertisement to the expected revenue value of each advertisement. In one embodiment, the modifier is computed by estimating the feedback response from the particular user based on a statistical model. The statistical model may take into account the feedback received from the group of users.

In one embodiment, the online service generates a content item in response to receiving a request for the content item from the particular user. The content item may be embedded with the selected advertisements and then sent to the particular user. The content item may also include one or more graphical user elements (e.g., icons, symbols, a string of characters or any visual elements) or any combination thereof for receiving the feedback response about the selected advertisements from the user.

In one embodiment, the modifier is computed by deducting a second value from a first value. The first value is computed by multiplying a first coefficient to a number of positive feedback responses previously received from the other users. The second value is computed by multiplying a second coefficient to a number of negative feedback responses previously received. The first and second coefficients may be modified to place emphasis on positive feedback responses or negative feedback responses as well as change weight given to users' expected interest in the advertisement and weight given to the value of the advertisement to the online service provider.

### BRIEF DESCRIPTION OF THE DRAWINGS

FIG. 1 is a conceptual diagram illustrating an online service system for selecting and presenting advertisements, according to one embodiment.

FIG. 2A is a block diagram illustrating an online service computing device, according to one embodiment.

FIG. 2B is a block diagram illustrating an advertisement selector, according to one embodiment.

FIG. 3A is a block diagram illustrating a user device for a user to view advertisements and provide feedback responses about the advertisements, according to one embodiment.

FIG. 3B is a graphical user interface image illustrating a content item loaded and displayed by an Internet browser, according to one embodiment.

FIG. 3C is a graphical user interface image of a media player displaying an advertisement, according to one embodiment.

FIG. 4 is a flowchart illustrating processes for selecting and presenting advertisements by taking into account the users' expected interest in advertisements, according to one embodiment.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

Embodiments select advertisements to be presented to a user based on feedback responses previously received from other users where the feedback responses represent the level of interest to the advertisements expressed by the other users. A plurality of advertisements may compete for advertisement via an online service. In selecting advertisements to be presented to a user, the online service takes into account feedback responses previously collected from a group of users as well as revenue that the online service is expected to earn by presenting certain advertisements to the user. An online service computing device computes a total value of an advertisement based on an estimated revenue value for presenting an advertisement and a modifier representing the user's estimated interest in the advertisements. The online service then selects or prioritizes the advertisements based on the total values. Advertisements with more positive feedback responses and/or less negative feedback responses tend to have higher total values, and therefore, such advertisements are more likely to be selected for presentation to the users. In this way, the users' overall experience with the online service can be enhanced, and therefore, attract more users to the online service.

An expected revenue value represents an advertisement fee expected to be collected by presenting an advertisement to a user. The expected revenue value represents the value of the advertisement to an online service provider. The expected revenue value can be derived or may be the same as bid price of an advertisement. The expected revenue value may be, for example, Cost Per Impression (CPI), Cost Per Click Through (CPC), Cost Per Lead (CPL), Cost Per Sale (CPS) or Cost Per Transaction (CPT).

A modifier represents a user's level of interest in an advertisement estimated by the online service. A higher modifier indicates higher likelihood that the advertisement is of interest to the user. Conversely, a lower modifier indicates less likelihood that the advertisement is of interest to the user. In one embodiment, the modifier is computed from feedback responses previously received from users with respect to the advertisement.

An total value refers to a combination of the estimated revenue value of an advertisement and a user's expected interest in the advertisement. Different weights may be assigned to the expected revenue value and the modifiers to change emphasis on the user's expected interest or the estimated revenue value in selecting the advertisements to be presented to the user.

A feedback response received from a user indicates the user's interest in the advertisement as determined by the user. A positive feedback response indicates that an advertisement is of interest to the user. Conversely, a negative feedback response indicates that the user has no interest or has minimal interest in an advertisement.

### User Value Oriented Advertisement Model

Some conventional online services take into account the user's likely interest in an advertisement when determining which advertisements to present to the user. For example, some conventional online services consider factors such as the user's demographic profile to estimate the click-through-rate of the user on an advertisement. However, such click-through-rate does not provide an accurate measure of the user's level of interest because the user may decide not to click the advertisement even when the advertisement is of interest to the user or vice versa. Further, selecting advertisement based on the click-through-rate or other similar schemes remain focused on increasing advertisement revenue collected by an online service provider. Hence, even if an advertisement significantly degrades user experience, such advertisement is likely to be presented to the user if an advertiser commits to pay a higher advertisement fee for the advertisement. However, if the advertisement degrades the user experience, more users may refrain from using the online service to access content items, leading to decreased or less increase in user traffic. The decreased user traffic will decrease the overall advertisement fee collected by the online service provider over time. On the contrary, if the user experience is enhanced by relevant and value-adding advertisements, user traffic is likely to increase over time. Hence, it is advantageous to select and present advertisements that are likely to be of interest to the users more often than advertisements that are or minimal or no interest to the users.

Embodiments take into account a user's expected interest in the advertisement when selecting and/or prioritizing multiple advertisements that compete for presentation to the user via the online services. Advertisers may submit bid prices for advertisements to present the advertisements via the online services. The higher the bid prices, the more likely that a corresponding advertisement is to be presented via the online services.

In one embodiment, a total value of an advertisement is obtained by adding a premium value to an expected revenue value of the advertisement if the advertisement is likely to be of interest to the user whereas the total value is obtained by deducting a discount value from an expected revenue value when the advertisement is likely to be of no interest to the user. After obtaining the total values, the total values are compared to select advertisements for inclusion in the content items.

The premium value and discount value may be estimated based on various statistical models. In one embodiment, the premium value and the discount value for a user are determined based on previous feedback responses from other users previously presented with the advertisements. The feedback responses may indicate the other users' liking/disliking of the advertisements or the degree of linking/disliking of the advertisements. Such feedback responses may function as a proxy for determining the other user's interest in the advertisements.

An advertisement may be of interest to the users in various ways including, but not limited to: (i) providing information about services or products that users are searching for, (ii) increase awareness or knowledge on matters helpful to users, (iii) help users save time or costs and (iv) provide entertainment to users. Conversely, an advertise may be of no interest to the user in various ways including, but not limited to: (i) providing information irrelevant to users, (ii) covering products or services that offend users, (iii) promoting illegal or unethical actions, and (iv) including misleading or inaccurate information.

### Architecture of Online Service System

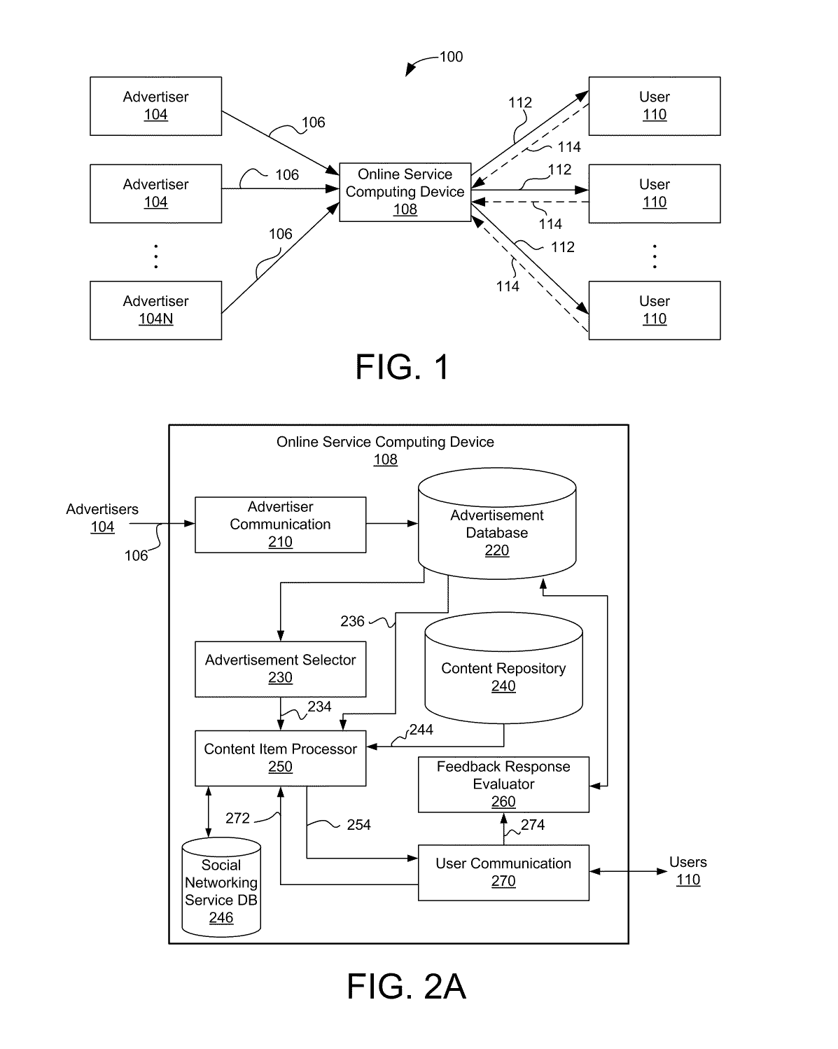

FIG. 1 (Figure) is a conceptual diagram illustrating an online service system 100 for selecting and presenting advertisements to users 110, according to one embodiment. The online service system 100 includes an online service computing device 108 that performs one or more of the following functions: (i) receive a plurality of advertisements 106 and related information from one or more advertisers 104, (ii) select and/or prioritize the advertisements 112 for presentation to the users 110, (iii) send advertisements 112 (either embedded in content items or separate from the content items) to the users, and (iv) receive feedback responses 114 about the advertisements 112 from the users 110. Although not illustrated in FIG. 1, the advertisers 104, the users 110 and the online service computing device 108 may communicate via a network (e.g., Internet).

The advertisers 104 submit advertisements 106 for dissemination to users 110 via the online service computing device 108. The advertisers 104 may include, for example, corporations, public entities (e.g., government), and private individuals desiring to distribute advertisements via the online service system 100. The advertisers 104 may also provide information associated with advertisements such as the characteristics of the products or services being advertised, the profile of targeted users, the advertisement fees (i.e., expected revenue values) that the advertisers are willing to pay, and the total cap amount of advertisement fee for a certain duration (e.g., daily and monthly).

The advertisements 106 may be in various digital forms such as graphical images (such as so-called banner advertisements), string of alphanumeric characters, audio or video file and any combinations thereof. The advertisements may also be in the form of a link to other online resources or machine executable instructions. The advertisements may be included in contents items generated and sent from the online service computing device 108 or sent as data separate from the content items.

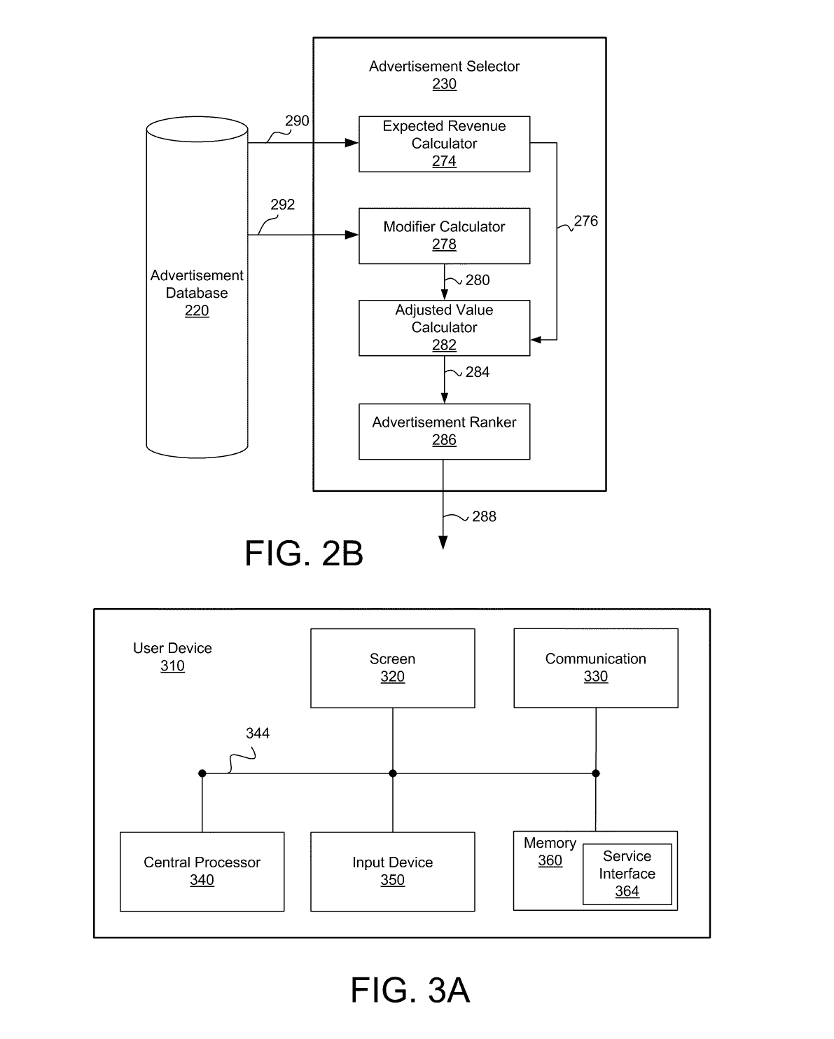

The online service computing device 108 is a computing device that processes requests from the advertisers 104 and the users 110 to provide various types of online services, for example, as described below in detail with reference to FIGS. 2A and 2B. The online services provided by the online service computing device 108 include, but are not limited to, social networking service, Internet search service, data processing, online shopping services and media streaming services.

In one embodiment, the online service computing device 108 receives requests for content items from the users 110 and provides the content items to the users 100. The content items provided by the online service computing device 108 include, but are not limited to, feeds, web pages, images, audio/video files, documents, executable programs, images, search results, and processed data. The content items 112 may be embedded with the advertisements 106.

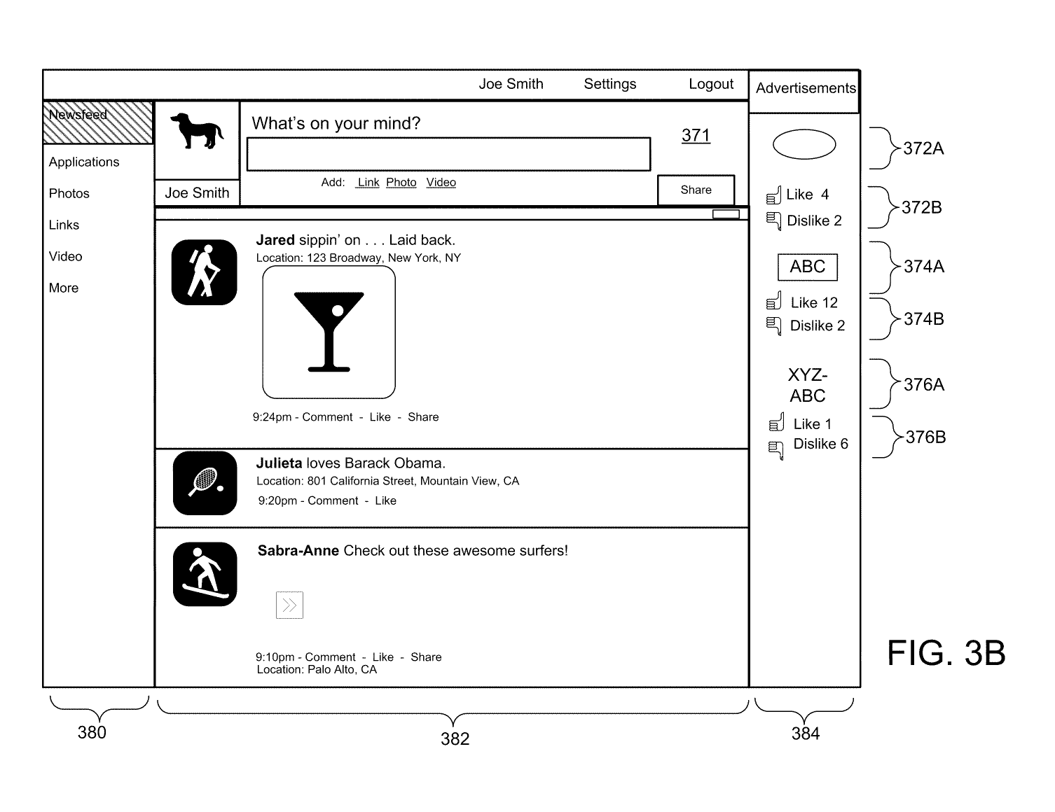

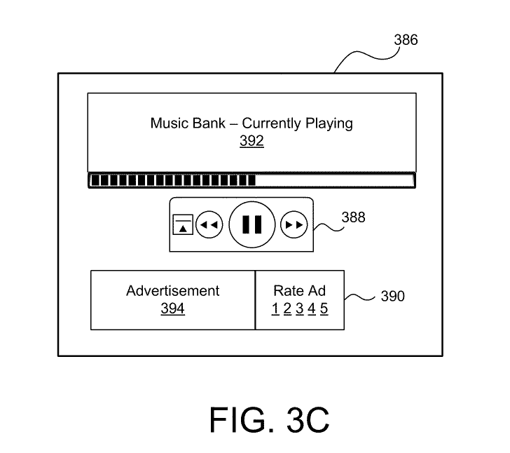

After being presented with the advertisements on their computing devices, the users 110 may choose to provide the feedback responses 114 about the advertisements 112 to the online service computing device 108 by interacting with the content item. For this purpose, the content item may include graphical user interface elements such as icons, numbers, symbols and any visual elements or any combination thereof for receiving the feedback responses 114. The content item may also include non-graphical user interface elements such as auditory icons for receiving feedback responses 114 from visually impaired users. In one embodiment, the feedback response may be provided by presenting the user with two options: (i) one option associated with a negative feedback response (i.e., low or no interest to the user) and (ii) the other option associated with a positive feedback response (i.e., high interest to the user). For example, the feedback response may be provided simply by clicking a “like” icon or a “dislike” icon displayed on the screen of the user's computing device, as described below in detail with reference to FIG. 3B or choosing a number as described below in detail with reference to FIG. 3C. Reducing the number of options is advantageous because data gathering can be facilitated and users are generally more willing to provide feedback responses when presented with a smaller number of choices.

Although the advertisers 104 and the users 110 are illustrated in FIG. 1 as communicating directly with the online service computing device 108, the advertisers 104 and the users 110 will communicate with the online service computing device 108 using their computing devices in most applications. The computing devices used by advertisers 104 and the users 110 may include, but are not limited to, desktop computers, laptop computers, mobile phones, setup boxes and game consoles. Example architecture of a computing device for users (hereinafter referred to as a “user device”) is described below in detail with reference to FIG. 3A.

### Structure of Example Online Service System

FIG. 2A is a block diagram illustrating the online service computing device 108, according to one embodiment. The online service computing device 108 may include, among other components, an advertiser communication module 210, an advertisement database 220, an advertisement selector 230, a content repository 240, a content item processor 250, a feedback response evaluator 260, a user communication module 270 and a social networking service database 246. One or more of these components may be embodied as software, hardware, firmware or any combination thereof. Further, one or more of these components may be combined into a single component. For example, the advertiser communication module 210 and the user communication module 270 may be combined into a single module.

The advertiser communication module 210 is hardware, software, firmware or a combination thereof for communicating with the advertisers 104. The advertisers 104 send advertisements 106 and information related to the advertisements to the advertiser communication module 210 via a network (not shown).

The advertiser database 220 is hardware, software, firmware or a combination thereof for storing advertisements and information related to the advertisements. The advertiser database 220 is connected to the advertiser communication module 210 to receive advertisements and other related information from the advertiser communication module 210. The information related to advertisement includes, for example, the characteristics of the products or services being advertised, the profile of targeted users, the bidding price for advertisement that the advertisers are willing to pay for presenting advertisements, the maximum amount of advertisement fee for a predetermined duration (e.g., daily and monthly), and user feedback responses 114 received for the advertisements.

The advertisement selector 230 is hardware, software, firmware or any combinations thereof for selecting or prioritizing the advertisements to be presented to the users 110, as described below in detail with reference to FIG. 2B. The advertisement selector 230 outputs indexes of one or more advertisements 234 selected for presentation to the users 110. If multiple advertisements 234 are to be presented to the users 110, the advertisement selector 230 can prioritize the advertisements. In one embodiment, advertisements are embedded in the content items served by the online service computing device 108. In this embodiment, a selected advertisement with the highest priority is placed at the most prominent location of the content item whereas other selected advertisements with lower priority are placed at less prominent locations of the content item.

The content repository 240 stores resource data for generating the content items as requested by the users 110. The resource data for generating the content items may include, but are not limited to, documents, image files, video files and audio files. In one embodiment, the resource data in the content repository 240 include feeds or data provided by the users 110 for sharing.

The content item processor 250 is hardware, software, firmware or any combinations thereof for generating content items in response to receiving requests 272 from the users 110 via the user communication module 270. In one embodiment, the content item processor 250 receives indexes 234 of the one or more selected advertisements and retrieves the advertisements 236 corresponding to the indexes 234 from the advertisement database 220 after receiving the requests 272. Also, the content item processor 250 receives resource data 244 from the content repository 240, and combines the advertisements 236 and the resource data 244 to generate content items for the users 110. The content items generated by the content item processor 250 may be web pages formatted to include images and texts. If the web pages include multiple locations where advertisements may be placed, advertisements with higher priority (as determined by the advertisement selector 230) may be placed at more prominent locations of the web page. The generated content items 254 are sent to the users 110 via the user communication module 270.

In another embodiment, the content item processor 236 does not embed advertisements in the content items. Instead, the advertisement selector 230 selects the advertisements to be sent to the users 110, and sends the advertisements to the users 110 via the user communication module 270. The content item processor 250 generates the content items without including any advertisements.

The feedback response evaluator 260 is hardware, software, firmware or any combinations thereof for processing user feedback responses 114 received from the users 110. The feedback response evaluator 260 is coupled to the user communication module 270 to receive feedback response data 274 extracted by the user communication module 270. The feedback response data 274 may include, for example, an identifier of the advertisement and a feedback response value associated with the advertisement.

The feedback response value may represent a user's liking/disliking of the advertisements that functions as a proxy for the user's interest in the advertisements as determined by the user. The feedback response value can have one of two values (e.g., zero to indicate a user's disliking of an advertisement and one to indicate the user's liking of the advertisement). Alternatively, the feedback response value could be one of multiple values to indicate the degree of liking or disliking of an advertisement (e.g., zero indicating strong disliking of an advertisement, higher values progressively indicating more favorable assessment of the advertisement, and five indicating the most favorable assessment of the advertisement).

In one embodiment, the feedback response evaluator 260 identifies the advertisement associated with the feedback response data 274 based on the identifier, retrieves a current feedback response value of the advertisement from the advertisement database 220, updates the feedback response value to reflect the newly received feedback response data 274, and stores the updated feedback response value in the advertisement database 220. The updated feedback response value may then be retrieved by the advertisement selector 230 to select advertisements for subsequent presentation to the users 110.

The user communication module 270 is hardware, software, firmware or a combination thereof for communicating with the users 110 via a network. The user communication module 270 is coupled to the content item processor 250 to forward requests 272 received from the users 110 for the content items and to send the content items 254 generated by the content item processor 250 to the users 110. The user communication module 270 is also coupled to the feedback response evaluator 260 to send any feedback response data 274 extracted from data received from the users 110.

In one embodiment, the online service computing device 108 provides social networking services that allow users to establish relationships, share information and facilitate communication among the users. For this purpose, the online service computing device 108 includes a social networking service database 246. The social networking service database 246 stores, among other information, relationship between users (e.g., “friends” or “followers”) and profile information of each user. The social networking database 246 may also store privacy information indicating the range of information to be shared with different groups of users. The social networking service database 246 provides information to the content item processor 250 so that the content item processor 250 may compile and generate a content item customized for each user based on the user's relationship with other users.

The online service computing device 108 may be embodied in a single server or multiple servers. In embodiments where the online service computing device 108 is embodied on multiple servers, each server embodies a subset of the components illustrated in FIG. 2A. Further, each server may be located at different geographic locations to serve users in different geographic locations.

In one embodiment, components of the online service computing device 108 illustrated in FIG. 2 are stored in a computer-readable storage medium. Instructions of the software modules are retrieved and executed by a central processor in the online service computing device 108. The computer-readable storage medium for storing the software modules may be volatile memory such as RAM, non-volatile memory such as a flash memory or a combination thereof.

### Architecture of Example Advertisement Selector

FIG. 2B is a block diagram illustrating an advertisement selector 230, according to one embodiment. The advertisement selector 230 may include, among other components, an expected revenue calculator 274, a modifier calculator 278, a total value calculator 282 and an advertisement ranker 286. One or more of these components may be embodied as hardware, software, firmware of a combination thereof.

The expected revenue calculator 274 receives a bid price 290 from the advertisement database and computes expected revenue corresponding to the bid price 290. The computation of expected revenue may include normalizing the bid price 290 into a normalized value for adjustment and comparison. The bid price 290 indicates an advertisement fee that the advertisers committed to pay for presenting an advertisement to a user. The bid price may be expressed in terms of different pricing structure such as Cost Per Impression (CPI), Cost Per Action (CPA) and fee commitments under any other fee structure. The expected revenue calculator 274 may normalize such bid price expressed in different fee structures into expected revenue values under the same cost structure. For example, if a bid price is expressed in Cost Per Click (CPC), this bid price can be converted into CPI using the following equation (1):

eCTR·CPC=CPI equation (1)

where eCTR is an estimated Cost Per Click-Through. Conversion of an expected revenue value in one fee structure to another fee structure is well known in the art, and hence, a detailed description thereof is omitted herein for the sake of brevity. The expected revenue calculator 274 may perform other normalization such as currency conversion if the advertisement fees are expressed in different currencies.

The modifier calculator 278 computes a modifier (i.e., a premium value to be added to the normalized expected revenue value or a discount value to be deducted from the normalized expected revenue value). The modifier may be in the units of dollar or other currencies so that the modifier may be added or deducted from the expected revenue value. If available, the modifier calculator 278 receives user feedback statistical data 292 from the advertisement database 220 and computes the modifier based on the user feedback statistical data 292. The user feedback statistical data 292 represent the probability P(TU) of positive user feedback responses and the probability P(TD) of negative user feedback responses previously received for an advertisement. In one embodiment, P(TU) is computed as a ratio of the number of positive user feedback responses relative to the total number of feedback responses for an advertisement, and P(TD) is computed as a ratio of the number of negative user feedback responsive relative to the total number of feedback responses for the advertisement. The modifier calculator 278 computes a modifier FMₓ for an advertisement X, for example, using the following equation:

FMₓ=a·P(TU)ₓ−b·P(TD)ₓ equation (2)

where “a” is a coefficient of a positive value representing weight to be given to the positive user feedback responses, “b” is a coefficient of a positive value representing weight to be given to the negative user feedback responses, P(TU)ₓ is the probability of positive feedback responses from users for the advertisement X and P(TD)ₓ is the probability of negative feedback responses from the users.

The coefficients “a” and “b” may be set to place emphasis on positive feedback responses or negative feedback responses. Further, the coefficients “a” and “b” may also indicate weight given to the user's expected interest in the advertisement and weight given to the value of the advertisement to the online service provider in selecting or prioritizing the advertisements. By increasing “a” and/or “b” coefficients relative to expected revenue values, a total value becomes more dependent on user feedback responses.

In one embodiment, the modifier is computed by taking into account one or more variables in addition to the probability of positive feedback responses and the probability of negative feedback responses. The additional variables taken into account in determining the modifier may include, but are not limited to: (i) Click-Through Rate (CTR) of advertisements, (ii) the rate of clicks that results in sale of products or services, (iii) the time the user retains the content item on the user's computer, (iv) types of positive or negative feedback responses, (v) the length of advertisement for audio or video advertisements, and (vi) click length indicating the amount of time after the user clicks an advertisement and then returns to previous webpage.

In one embodiment, the modifier calculator 278 retrieves the user profile of the user requesting the content item, and computes the modifiers to take into account user characteristics such as age, gender, location and the marital status of the user. In one embodiment, the modifier calculator 278 computes modifiers for each particular user by taking into account only feedback responses received from other users with demographic profile similar to the particular user or feedback responses received from other users having social relationships, as stored in the social networking service database 246.

If the user feedback statistical data 292 are not available from the advertisement database 220 (e.g., because no user feedback response has yet been received), the modifier calculator 278 may use a statistical model to estimate the probability of positive user feedback responses and the probability of negative user feedback responses. The statistical model may take into account various factors such as the category of products or services being advertised, demographics of purchasers, track records of advertisements on other similar products or services, and user feedback responses on other advertisements from the same advertiser.

In one embodiment, the actual number of positive user feedback responses P(TU) and the negative user feedback responses P(TD)ₓ in equation (2) are replaced with the predicted number of positive user feedback responses eP(TU) and the predicted number of negative feedback responses eP(TD) to obtain the modifier. The statistical model may also be used when there are a small number of feedback responses. The statistical model may take into account feedback responses previously received from the user as well as various factors such as the category of products or services being advertised, demographics of purchasers, track records of other similar products or services, and user feedback responses on other advertisements from the same advertiser.

Various other equations and factors may be employed to obtain the modifiers. For example, instead of using the number of positive/negative feedback responses, a percentage of negative feedback response and a percentage of positive feedback response may be used to compute the modifiers.

The total value calculator 282 computes total values. A total value is a combination of the advertisement fee to the online service provider (i.e., the advertisement fee collected) and a user's expected interest in the advertisement. To calculate the total value, the total value calculator 282 receives normalized expected revenue values 276 from the expected revenue calculator 274 and the modifiers 280 from the modifier calculator 278. In one embodiment, bid prices of the advertisements are processed into expected revenue values that are expressed in terms of CPI. In this embodiment, the total value in the form of adjusted CPI (i.e., aCPI) for an advertisement X is computed using the following equation:

aCPI=CPIₓ+FMₓ equation (3)

where CPIₓ represents CPI for advertisement X, and FMₓ represents a modifier for adjusting the CPI value.

The advertisement ranker 286 compares the total values of multiple advertisements and selects one or more advertisements with higher total values. Specifically, the advertisement ranker 286 receives the total values 284 from the total value calculator 282, processes the total values (if needed), and selects the advertisements with higher total values for presentation to the users 110. The advertisement ranker 286 outputs the indexes 288 of the selected advertisements to the content item processor 250. If multiple advertisements are selected by the advertisement ranker 286, the selected advertisements may be prioritized for placement at different locations of the content item. That is, selected advertisements with higher total values may be placed at a more prominent location of the content item. In embodiments where advertisements are sent separate from the content items, the advertisement selector 230 retrieves the advertisements corresponding to the indexes, and sends the selected advertisements to the users 110.

Although the expected revenue calculator 274, the modifier calculator 278, the total value calculator 282 and the advertisement ranker 286 are illustrated in FIG. 2B as separate components, one or more of these components may be combined into a single module. Also, one or more components illustrated in FIG. 2B may be omitted. For example, the expected revenue calculator 274 may be omitted if no normalization is needed.

### Example User Device

FIG. 3A is a block diagram illustrating a user device 310 for viewing advertisements and receiving feedback responses with respect to the advertisements, according to one embodiment. The user device 310 is accessed by a user to receive and access advertisements and content items from the online service computing device 108. The user device 310 may be various devices with communication capability including, but not limited to, desktop computers, laptop computers, mobile phones, setup boxes and game consoles. The user device 310 may be a personal device (e.g., personal laptop computer) used by a single user or a shared/public device (e.g., interactive kiosks) used by multiple users.

The user device 310 may include, among other components, a screen 320, a communication module 330, a central processor 340, an input device 350 and memory 360. These components of the user device 310 are connected to each other via a bus 344. Numerous other components and variations are possible to the hardware architecture of the user device 310.

The screen 320 displays images or texts associated with the content items. The screen 320 may be embodied using various display technology such as liquid crystal display (LCD).

The central processor 220 executes various operations on the user device 310 by executing computer instructions stored in the memory 360. The central processor 340 communicates with the screen 320, the input device 350, the communication module 330 and the memory 360 via the bus 344 to control operations of these components.

The communication module 330 is hardware, software, firmware or a combination thereof for transmitting and receiving signals for communicating with the online service computing device 108. The communicated signals may include data corresponding to content items, advertisements, and user feedback responses associated with the advertisements.

The memory 360 is a computer readable storage medium for storing instructions executed by the central processor 340. The memory 360 may be volatile memory such as RAM, non-volatile memory such as a flash memory or a combination thereof. The memory 360 may store various software modules including, among others, an operating system, user applications and a service interface 364.

The service interface 364 is a set of instructions executed by the central processor 340 to interact with the online service computing device 108. The service interface 364 sends requests for content items to the online service computing device 108, receives the content items and/or advertisements in response to the requests, and presents the content items and/or advertisements to the users. The service interface 364 also receives user input associated with feedback responses about the received advertisements, and sends the user feedback responses to the online service computing device 108.

In one embodiment, the service interface 364 is embodied as an Internet browser. The service interface 364 receives the content items and renders graphical user interface images, for example, as described below in detail with reference to FIG. 3B. In another embodiment, the service interface 364 is embodied as an application (e.g., media player) for loading and presenting a media content item to the users. The service interface 364 receives and displays the advertisements in an area of the screen occupied by a graphical user interface of the service interface 364, for example, as described in detail with reference to FIG. 3C.

### Example User Interfaces for Presenting Advertisements and Receiving Feedback Response

FIG. 3B is a graphical user interface image illustrating a content item loaded and displayed by an Internet browser, according to one embodiment. The content item in FIG. 3B is received from an online social networking service that provides various media content items posted and shared by multiple users. The user content item includes a navigation area 380, a newsfeed display area 382 and an advertisement area 384. The navigation area 380 allows users to navigate to different services provided by the online service. By clicking different tabs (e.g., “newsfeed,” “applications,” “photos,” “links,” “video,” and “more”), the browser sends requests to the online service computing device 108 requesting content items corresponding to the clicked tab, receives the updated content items, and renders images on the screen by processing the received content items.

The newsfeed display area 382 displays a newsfeed provided by “friends” or other users sharing contents via online service computing device 108. The user “Joe Smith” accessing the content item 370 has “Jared,” “Julieta” and “Sabra-Anne” as friends, and can share messages or other media files (e.g., images or video file) with these friends by typing in a message and adding media files in user interface area 371. Uploading and displaying of a newsfeed in a social networking service can be performed, for example, as described in U.S. patent application Ser. No. 11/503,242 entitled “Communicating a Newsfeed of Media Content Based on a Member's Interactions in a Social Network Environment,” filed on Aug. 11, 2006, which is incorporated by reference herein in its entirety.

The advertisement area 384 displays three advertisements 372A, 374A and 376A. Below each advertisement, feedback response icons are displayed. Specifically, each of the areas 372B, 374B and 376B includes a “thumbs up” icon indicating a favorable or positive user feedback response, and a “thumbs down” icon indicating an unfavorable or negative user feedback response. When the user clicks the “thumbs up” icon or the “thumbs down” icon, the Internet browser sends signal to the online service computing device 108 to indicate a positive or negative feedback response from the user. The number of positive and negative user feedback responses previously received from other users is also displayed adjacent to “Like” and “Dislike” characters in the areas 372B, 374B and 376B.

The content item displayed in FIG. 3B is merely illustrative. Various other content items in various other layouts may be displayed on the screen 320 using the Internet browser. For example, the content items accessed by the Internet browser may include search results for a search term, online news articles and information related to online shopping.

FIG. 3C is a graphical user interface image for a media player displaying an advertisement, according to one embodiment. Unlike the embodiment of FIG. 3B, the embodiment of FIG. 3C is associated with a media player that plays multimedia files such as MP3 files. The user interface 386 of the media player includes a title box 392, a control box 388, an advertisement box 394 and an advertisement rating box 390. The title box 392 indicates the title of the media file currently being played on the media player. The control box 388 includes control icons for controlling various operations of the media player. The advertisement area 394 displays advertisements received from the online service computing device 108. The advertisement rating area 390 is used for receiving a user feedback response for an advertisement displayed in the area 394.

The advertisement displayed in the area 394 is selected and received from the online service computing device 108. A user viewing the advertisement may click any one of numbers 1 to 5 to provide negative or positive feedback responses as to the advertisement displayed in the area 394. The number “1” represents the most negative feedback response. Feedback responses become progressively more positive as the number increases, and the number “5” represents the most positive feedback response. After the user feedback response is received at the media player, the media player sends a signal to the online service computing device 108 indicating the user feedback response for the advertisement displayed in the area 394.

In one embodiment, the advertisement displayed in the user interface 386 may be included in the content item received from the online service computing device 108. In this embodiment, the media player extracts the advertisement from the content item and displays the advertisement in the area 394. Alternatively, the advertisement may be received separately from the content item. That is, the advertisement is not embedded in the content item but received as data separate from the online data.

The user interface for the media player displayed in FIG. 3C is merely illustrative. Various other user interfaces may be used to display advertisements and receive user feedback responses for the displayed advertisements. Further, although FIG. 3C is described with reference to a media player, other embodiments may place advertisements on other applications or use a different mechanism to receive user feedback responses associated with the displayed advertisement.

### Example Processes of Selecting or Prioritizing Advertisements

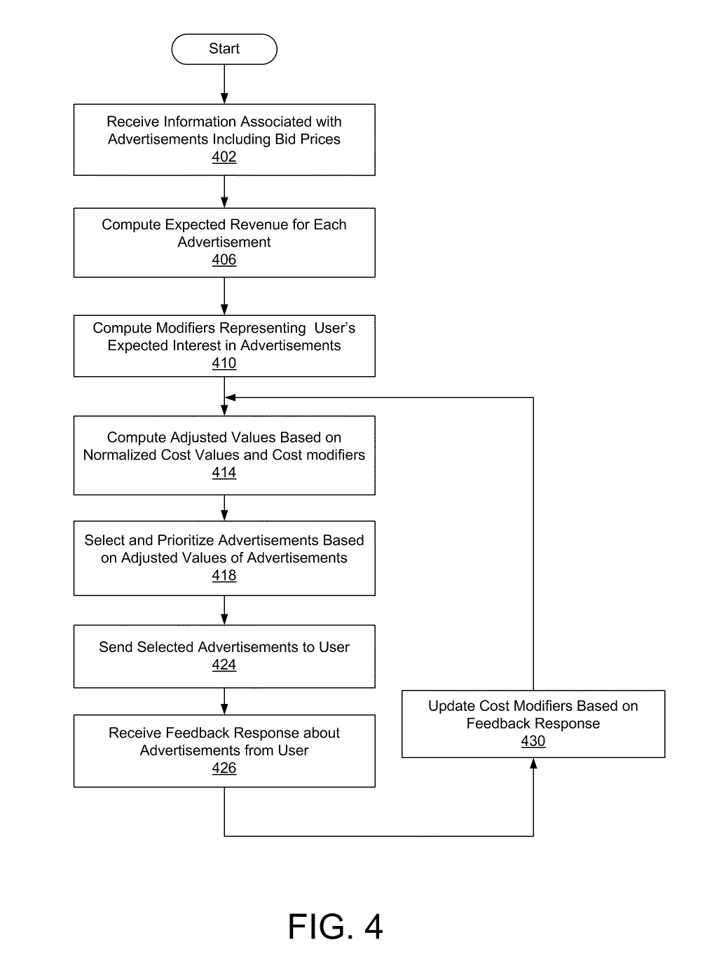

FIG. 4 is a flowchart illustrating processes of selecting or prioritizing advertisements for presentation to the users 110, according to one embodiment. The advertisement selector 230 receives 402 information associated with advertisements from the advertisement database 220. The information received at the advertisement selector 230 may include, for example, indexes of advertisements, expected revenue values associated with the advertisements, user feedback responses previously collected for the advertisements and statistical data associated with the advertisements.

The advertisement selector 230 then normalizes 406 the expected revenue values associated with the advertisements. The expected revenue values may be expressed in terms of different cost structures such as CPI and CPA. The advertisement selector 230 normalizes the expected revenue values expressed in different cost structures by converting the expected revenue values into normalized expected revenue values (e.g., CPI) under a single unified cost structure.

The advertisement selector 230 computes 410 the modifiers representing the user's expected interest in the advertisements. In one embodiment, a modifier of an advertisement is computed by (i) obtaining a first value by multiplying a coefficient to the number of positive user feedback responses related to the advertisement, (ii) obtaining a second value by multiplying another coefficient to the number of negative user feedback responses related to the advertisement, and (iii) deducting the second value from the first value. A higher modifier represents a higher value of the advertisement to the users.

The advertisement selector 230 then computes 414 the total values based on the normalized expected revenue values and the modifiers. In one embodiment, the total values are obtained by adding the modifiers to the normalized expected revenue values.

The advertisement selector 230 selects and prioritizes 418 the advertisements for presentation to the users 110 based on the total values of the advertisements. In one embodiment, the advertisement selector 230 selects one or more advertisements with higher total values.

The selected advertisements are then sent 424 to the user 110. In one embodiment, the selected advertisements are included in a content item and then sent to the user. In another embodiment, the advertisements are sent to the user 110 separate from a content item.

After presenting the advertisements to the user, the feedback response evaluator 260 receives 426 a user feedback response about the advertisements from the user. The feedback response evaluator 260 then updates 430 the modifiers of the advertisements presented to the user based on the user feedback response received from the user. Then the process returns to computing 414 the total values based on the updated modifiers and repeats subsequent processes 418 through 426.

The sequence of processes as illustrated in FIG. 4 is merely illustrative. For example, normalizing 410 the expected revenue values may follow computing 406 of the modifier. Further, some processes may be omitted. For example, the process of normalizing the expected revenue value may be omitted if all of the expected revenue values stored in the advertisement database 220 are expressed in the same cost structure.

In one embodiment, receiving the user feedback response and updating the modifier are performed in real-time. The online service computing device 108 may instantly effect the changes in the modifiers and reflect the changed modifiers in selecting or prioritizing advertisements. In another embodiment, the feedback responses received from users are stored and then batch processed to update the modifiers of multiple advertisements at a certain interval.

In one embodiment, the advertisements are received from a device other than the online service computing device 108. The online service computing device 108 determines the advertisements to be presented to the user and sends an identifier of the advertisements to the user device 310. In response to receiving the identifier, the user device 310 retrieves an advertisement corresponding to the identifier from the device storing advertisements.

### Fee Computation Based on Advertisement Ranking

The actual advertisement fee charged to an advertiser for presenting an advertisement may be computed in various ways. In one embodiment, after the advertisements are ranked based on aCPIₓ as described above in detail with reference to equations (1) through (3), the fees fCPI charged to advertisers are computed in terms of CPI values using the following equation:

fCPI(i)=CPI(i+1)+FM(i+1)−FM(i) equation (4)

where i represents the rank of the advertisement based on aCPI (lower i indicates higher priority of the advertisement), CPI (i+1) represents CPI value for an advertisement ranked at i+1, FM(i+1) represent a modifier for an advertisement ranked at i+1, and FM(i) represents a modifier for an advertisement ranked at i. In cases where advertisers bid prices for advertisements based on CPI values, equation (4) ensures that the advertisers are charged less than the bidding price.

Specifically, because the advertisement are ranked based on aCPI values, the following equations apply:

aCPI(i)=CPI(i)+FM(i)>aCPI(i+1)=CPI(i+1)+FM(i+1) equation (5)

Hence, the following equation is derived from equation (5):

CPI(i)>CPI(i+1)+FM(i+1)−FM(i)=fCPI(i) equation (6)

Equation (6) indicates that an advertiser for i^{th} advertisement is charged fCPI(i) that is lower than the bid price CPI(i). Adjusting the fees charged to the advertisers based on fCPI(i) is advantageous because the advertisers are charged less for the advertisements that are of value or interest to the users, promoting advertisers to submit advertisements that are more value or interest to the users. In other words, the online service provider subsidizes advertisements of value or interest to the users in the form of reduced advertisement fees to the advertisers.

In another embodiment, the advertisers are charged with advertisement fees that are unadjusted from the bidding CPI values. That is, the advertisers are simply charged by the bidding price submitted for each advertisement.

It is to be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable storage medium. Suitable computer-readable storage medium may include, among others, volatile (e.g., RAM) and/or non-volatile (e.g., ROM, disk) memory.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What is claimed is:

1. A computer-implemented method for selecting advertisements to present to a user of an online service, the method comprising:
receiving a plurality of advertisements, each advertisement associated with a bid price;
receiving feedback from a group of users representing a level of interest explicitly indicated by the group of users for each of at least a subset of the advertisements;
for each of at least the subset of the advertisements;
computing an expected revenue value for presenting each advertisement to a particular user based on the bid price; and
computing a total value of each advertisement based on the expected revenue value and the feedback received for each advertisement; and
selecting one or more advertisements for presentation to the particular user from the plurality of advertisements based at least in part on the total values of the advertisements; and
sending the selected one or more advertisements for display to the particular user.

2. The method of claim 1, further comprising:
computing a modifier for each advertisement based on the feedback received from the group of users, each total value of the advertisement computed by adding the modifier for each advertisement to the expected revenue value of each advertisement.

3. The method of claim 2, wherein the modifier is computed by estimating a feedback response from the particular user based on a statistical model.

4. The method of claim 3, wherein the statistical model takes into account the feedback received from the group of users.

5. The method of claim 2, wherein computing the modifiers comprises:
obtaining a first value by multiplying a first coefficient to a number of positive feedback responses received from the group of users;
obtaining a second value by multiplying a second coefficient to a number of negative feedback responses received from the group of users; and
computing the modifiers by deducting the second value from the first value.

6. The method of claim 2, wherein computing the total values comprises adding the modifier of each advertisement to the expected revenue value of each advertisement.

7. The method of claim 1, wherein the expected revenue value is a Cost Per Impression (CPI).

8. The method of claim 1, further comprising normalizing expected revenue values by converting the expected revenue values expressed in a first cost structure into normalized expected revenue values in a second cost structure.

9. The method of claim 1, further comprising:
generating a content item responsive to receiving a request for the content item from the particular user, wherein the content item includes the selected one or more advertisements and one or more graphical user interface elements for receiving the feedback from the particular user, the generated content item sent to the particular user.

10. The method of claim 9, wherein the one or more graphical user interface elements comprises an icon for indicating a high level of interest to an advertisement by the particular user.

11. The method of claim 10, wherein the icon is a thumbs up.

12. The method of claim 11, wherein the group of users are associated with the particular user in a social networking service.

13. The method of claim 1, further comprising determining an advertisement fee for presenting an advertisement to the particular user based on the feedback for the advertisement.

14. An online service computing device for selecting advertisements for presentation to a user, comprising:
an advertisement selector configured to:
compute expected revenue calculator configured to receive a plurality of advertisements and bid prices, each bid price associated with an advertisement;
for each of at least the subset of the advertisements;
compute, based on the bid price, an expected revenue value for presenting each advertisement to a particular user;
compute a total value of each advertisement based on an expected revenue value and feedback received from a group of users for each advertisement representing a level of interest explicitly indicated by the group of users for at least a subset of the advertisements; and
select one or more advertisements for presentation to the particular user from the plurality of advertisements based at least in part on the total values of the advertisements;
a user communication module configured to:
receive the feedback from the group of users; and
sending the selected one or more advertisements for display to the particular user.

15. The online service computing device of claim 14, wherein the advertisement selector comprises a modifier calculator configured to compute a modifier for each advertisement based on the feedback received from the group of users, each total value of the advertisement computed by adding the modifier for each advertisement to the expected revenue value of each advertisement.

16. The online service computing device of claim 15, wherein the modifier is computed by estimating a feedback response from the particular user based on a statistical model.

17. The online service computing device of claim 16, wherein the statistical model takes into account the feedback received from the group of users.

18. The online service computing device of claim 15, wherein the modifier calculator is configured to:
obtain a first value by multiplying a first coefficient to a number of positive feedback responses received from the group of users;
obtain a second value by multiplying a second coefficient to a number of negative feedback responses received from the group of users; and
compute the modifiers by deducting the second value from the first value.

19. The online service computing device of claim 15, wherein the advertisement selector is configured to obtain the total value of each advertisement by adding the modifier of each advertisement to the expected revenue value of each advertisement.

20. The online service computing device of claim 14, wherein the estimated revenue is a Cost Per Impression (CPI).

21. The online service computing device of claim 14, wherein the advertisement selector is further configured to normalize the expected revenue values by converting the expected revenue values expressed in a first cost structure into normalized expected revenue values in a second cost structure.

22. The online service computing device of claim 14, further comprising a content item processor configured to:
generate a content item responsive to receiving a request for the content item from the user, wherein the content item includes the selected one or more advertisements and one or more graphical user interface elements for receiving the user feedback response from the user; and
send the generated content item to the user.

23. The online service computing device of claim 14, further comprising:
a content item processor configured to generate a content item responsive to receiving a request for the content item from the particular user, wherein the content item includes the selected one or more advertisements and one or more graphical user interface elements for receiving the feedback from the particular user, the generated content item sent to the particular user.

24. The online service computing device of claim 23, wherein the one or more graphical user interface element comprises a thumb-up icon.

25. The online service computing device of claim 14, wherein an advertisement fee charged for presenting an advertisement is determined based on the feedback for the advertisement.

26. A computer-readable storage medium storing instructions, the instructions when executed by a processor in an online service computing device for selecting advertisements for presentation to a user, causes the processor to:
receive a plurality of advertisements and bid prices each associated with an advertisement;
receive feedback from a group of users representing a level of interest explicitly indicated by the group of users for at least a subset of the advertisements;
for each of at least the subset of the advertisements;
compute an expected revenue value for presenting each advertisement to a particular user based on the bid price; and
compute total values of the advertisements based on the expected revenue value and the feedback received for each advertisement; and
select one or more advertisements for presentation to the particular user from the plurality of advertisements based at least in part on the total values of the advertisements; and
send the selected one or more advertisements for display to the particular user.
